(19) United States
(12) Patent Application Publication
(10) Pub. No.: US 2014/0007753 A1
(43) Pub. Date: Jan. 9, 2014

(54) STRING INSTRUMENT

(71) Applicant: MARK ERISMANN, Aarau (CH)

(72) Inventor: MARK ERISMANN, Aarau (CH)

(73) Assignee: TRIFF AG, AARAU (CH)

(21) Appl. No.: 13/934,653

(22) Filed: Jul. 3, 2013

(30) Foreign Application Priority Data
Jul. 4, 2012 (CH) 2012 1039/12

(51) Int. Cl. G10D 3/04

(52) U.S. Cl. CPC G10D 3/04
USPC 84/298

(57) ABSTRACT

The invention relates to a string instrument, in particular a guitar (10B). The bridge (24B) is disposed on the upper side (20) of an instrument body (12B). The bridge (24B) is furnished with a receiver groove (26), which runs perpendicular to the strings (30) of the instrument (10B). A bridge insert (28) is inserted into the receiver groove (26). The receiver groove (266) exhibits a bridge body (70) inserted into the receiver groove (26) of the bridge (24B) and a string contact element (74) disposed at the end (72) of the bridge body (70) turned away from the instrument body (12B). The string contact element (74) serves as a support for strings (30) and is formed harder than the bridge body (70) in order to prevent a cutting in of the strings (30) into the bridge insert (28) and in order to maintain the sound quality constant over a long time period.

The present invention concerns a string instrument according to the preamble of patent claim 1. String instruments, as well as also guitars, exhibit on an upper side of an instrument a bridge arrangement, over which bridge arrangement the tensioned strings of the instrument are guided. The bridge arrangement creates a physical connection between the strings and the upper side of the instrument body. The oscillations of the respective strings are transferred through the bridge arrangement in the electrically onto the upper side of the instrument body or, respectively, onto the vibration pickup elements during play of the string instrument.

The instrument body amplifies the oscillations of the strings and the string element rings out upon playing of for example a classic string instrument, where the instrument body forms a hollow shaped resonance body.

Upon playing of an e-guitar, where the instrument body of the e-guitar presents a rugged body, the oscillations of the strings are captured by way of oscillation pickup receiver elements, for example by piezo elements, such that the oscillations can be amplified by way of an amplifier.

Independent of the kind of the string instrument, the bridge arrangement has experienced little development in the past and comprises in general a bridge and a bridge insert plugged into a receiver groove of the bridge.

A string instrument of this kind is known from the German printed patent Document DE 103 52 420 A1. The string instrument exhibits an instrument body with strings tensioned at an upper side of the instrument body. The strings are attached at the instrument body with their two ends and the strings rest on a bridge with a bridge insert.

A further string instrument is known from the German printed patent document DE 10 2010 009 815 A1. This document shows a bridge solidly connected to an instrument body. The bridge exhibits a receiver groove, which runs perpendicular to the strings of the instrument, and a bridge insert which is inserted such in the receiver groove that over an upper narrow side of its bridge part projecting out of the receiver groove, the pretension and vibration caused string pressure forces of the strings attaching at the bridge part are transferable.

The bridge insert of the known kind are made usually of a more soft material such as for example plastic material, bone or wood. Correspondingly the danger exists with conventional bridge inserts that the strings cut into the more soft material of the bridge insert, which can negatively influence the sound of the instrument.

It is a further disadvantage with conventional bridge inserts, that during the tuning of the strings, the strings have to be pulled with a large resistance over the bridge insert because of the more soft material of the bridge insert and thus a tearing danger is present for the respective string. Therefore it is an object of the present invention to furnish the string instrument with a sound quality, which remains the same over a long time period. This object is obtained with a string instrument which exhibits the features of claim 1.

The string instrument according to the invention exhibits an instrument body and a bridge is disposed on an upper side of the instrument body. The bridge is furnished with a receiver groove, which runs perpendicular to the strings of the instrument. A bridge insert is such inserted that the prestress and vibration caused string pressure forces of the strings engaging at the bridge insert are transferable through an upper narrow side of the bridge insert. A lower narrow side of the bridge insert rests at the floor of the receiver groove at least indirectly, such that the vibrations of the strings are transferable as body sound by way of the bridge insert. The bridge insert exhibits according to the invention a bridge body inserted into the receiver groove of the bridge and a string contact element disposed at an end of the bridge body remote from the instrument body. The string contact element serves as a support for the strings and is formed harder than the bridge body in order to prevent the cutting in of the strings into the bridge insert and for maintaining a uniform sound quality over a long time period. Since the string contact element is formed harder than the bridge body, the string contact element serves as a hard and stable support for the respective string such that the string can be tensioned under a lesser resistance as with conventional bridge inserts during tuning of the respective string, since the respective string does not cut into the harder material. As a consequence, the tearing danger of the respective string during tuning is reduced.

In addition, the hard material of the string contact element improves the long term sound quality, since the respective string does not cut into the material and thus also no limitation in the freedom of motion of the oscillating strings occurs. This is associated with the consequence that the sound quality of the instrument can be adjusted optimally and can be maintained over long time periods, which is not the case with conventional bridge inserts, because of the above described disadvantages.

It is to be mentioned here that hard materials such as for example glass or metals, are used less in the production of conventional bridge inserts, since a bridge insert made out of these materials would weaken or, respectively, damp the oscillation force of the strings and correspondingly the instrument would sound less loud as a bridge insert produced from a softer material. Hard materials, however are associated with advantages, for example in the transfer of the string oscillations and in addition, the wear of the material in the contact region between the respective string and the bridge insert is reduced.

Furthermore it is to be mentioned here that it is also conceivable that a further material is disposed between the hard string contact element and the soft bridge body in order to optimize the body sound transfer from the strings to the instrument body or, respectively, the oscillation pickup receiver elements. The bridge insert according to the invention with the hard string contact element, the option of further material and the softer bridge body can be connected to each other by way of different gluing or, respectively, compounding techniques, wherein essentially the body sound transfer from the corresponding string subjected to oscillations, over the hard string contact element to the softer bridge body and from there to the bridge is performed undamped.

The bridge insert is thus inserted into the receiver groove that the bridge insert is movably supported at the groove flanks of the receiver groove according to a preferred embodiment of the present invention. This allows a good body sound transfer immediately to the floor of the receiver groove or, respectively, to the oscillation pickup receiver elements at the floor of the receiver groove.

The string contact element is formed like a profile and exhibits a convex round, in particular semicircular shaped rounded support face or a convex tipped running support with rounded support edge for the respective strings on an upper narrow side directed away from the instrument body. This effects an optimum and low tension guiding of the respective strings over the support face. The tearing danger of the strings during stringing and tuning of the string instrument is substantially reduced with the aid of the profile shaped string contact element.

According to a further embodiment, the string contact element exhibits a guiding groove for the respective string by way of which the respective string is led through. This effects a secure and optimum guiding of the respective string relative to the string contact element and prevents a lateral slippage of the respective string at pulling, striking or beating of the strings.

According to a further embodiment the string contact element extends, relative to a longitudinal direction of the bridge of the strung bridge middle plane, either straight line or convex bent over the full length of the bridge body or only in part over the length of the bridge body. This allows the adaptation of the bridge insert to the desired acoustic sound pattern

According to a further embodiment the string contact element exhibits for the corresponding string of a string contact element section and the string contact element sections are disposed at a distance from each other. This allows the support of one string per string contact element section. This assures that the corresponding strings rest optimally on the support faces or in the guide grooves of the string contact element sections.

It is also possible that the string contact element sections serve as a support for some strings and will not serve as a support for other strings.

According to a further embodiment the bridge body for each string contact element section exhibits an insertion groove, and the respective string contact element section is inserted in the coordinated insertion groove. This enables a compact mode of construction of the bridge insert according to the present invention, since the string contact element section can be formed narrow and optimum relative to the respective string.

According to a further embodiment the bridge body of the bridge insert is subdivided into bridge body sections by mold parting lines over the complete height, wherein the respective string contact element section is disposed at each bridge body section of the string contact element section extends as a single piece over several bridge body sections disposed successively in a row and mold parting lines disposed in between.

The body borne sound is advantageously separately transferred for each individual string to the respective bridge body sections for the case that the respective string contact element section is associated with the bridge body section. This leads to an improved body borne sound transfer from the respective string excited by oscillations to the instrument body or, respectively, to the coordinated oscillation pickup receiver elements. The physical separation of the bridge body sections prevents a body sound transfer to the neighboring oscillation pickup receiver elements. In the case that the string contact element section extends as a single piece over more than a bridge body section and the intermediately disposed mold seams, several strings can rest on the string contact element section, wherein despite everything the body sound in the separate bridge body sections is transferred with the above recited advantages. In the case that bridge body sections of the bridge insert are resting at each other, the body sound for the string concerned is transferred exclusively to the corresponding bridge body section. A guiding element for example, in particular a guiding wire, can serve here for the alignment of the bridge body sections lying at each other. Preferably, the mold parting lines (at least in part) are filled with a soft, in particular rubber elastic material such that the bridge body sections and/or string contact element sections are moveably connected to each other, wherein the bridge body sections are harder than soft material in the mold parting lines.

An upper narrow side of bridge body sections are turned toward the string contact element section and exhibits a groove, wherein a common guiding wire is led through the groove for holding aligned at least two next to each other of the disposed bridge insert sections. The string contact element is made out of a harder material, in particular metal or ceramic and the bridge body is made out of a softer material, in particular wood, plastic or bone. This allows an optimum bridge arrangement for the acoustic sound formation of the string instrument of the present invention. The oscillations pickup receiver elements, in particular a piezo element, is disposed between the bridge insert and the floor of the receiver groove of the bridge, preferably a string for the purpose of converting the oscillations of the respective strings into an electrical signal, which can be amplified by way of an electric amplifier. In this context it is to be mentioned that by means of immediate resting of the oscillation receiver element at the lower narrow side of the bridge insert, and indirect transfer of the body sound to the instrument body occurs, wherein the body sound is not transferred directly onto the instrument body from the bridge insert, but indirectly over the oscillation receiver elements, which additionally serve as body sound transfer agents in this case.

The oscillation pickup receiver element plays in particular then a roll when the sound of the string instrument is acoustically too quiet. The body sound can be directly tapped, captured and amplified by way of the oscillation pickup receiver element. Correspondingly quiet instruments, in particular those without a resonance body, such as can be the case for example with e-guitars, can be amplified.

It is also conceivable to furnish a bridge body, which is subdivided over its complete height by mold seams into bridge body sections, the mold seams are filled with the rubber elastic material and movably connect the bridge body sections to each other, wherein no hard formed string contact element section is applied to a bridge body section. Correspondingly the strings would rest immediately on the upper narrow sides of the bridge body sections.

Further advantages of the present invention are presented in the following description of embodiment examples, which will be illustrated and explained by way of the drawing.

There is shown in:

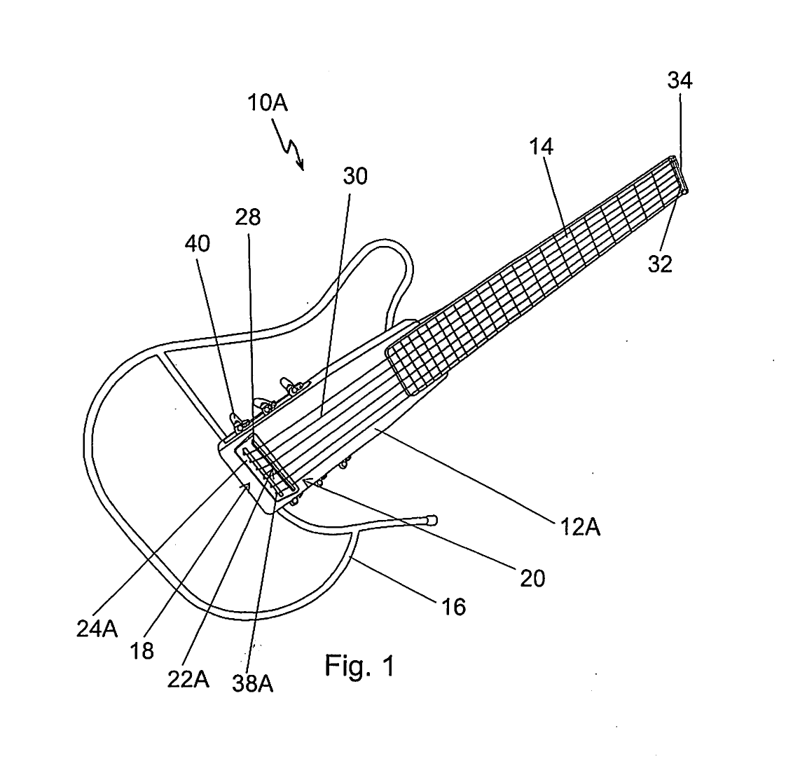

FIG. 1 is a perspective presentation of a guitar with an instrument body, a body support disposed at the instrument body and the strings tensioned over the instrument body, which strings are led over a bridge insert according to the invention;

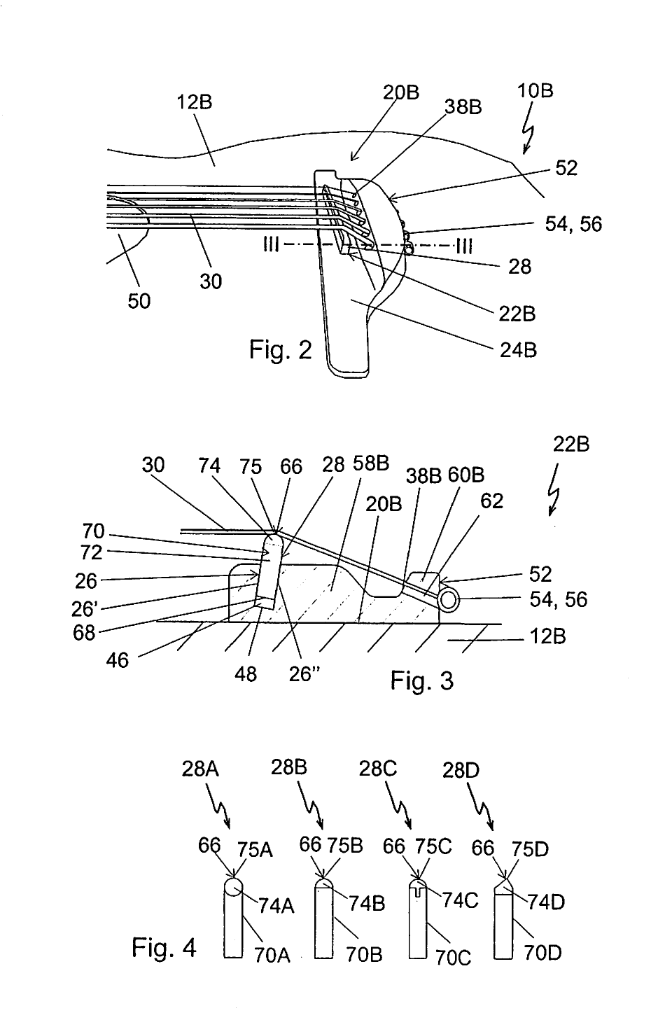

FIG. 2 is a perspective presentation of a part of a further guitar with an instrument body formed as a hollow body and with strings led over the bridge insert according to the invention;

FIG. 3 is a cross-section along the line III-III of FIG. 2 through a bridge with the receiver groove, wherein the bridge insert according to the invention is together with a bridge body and a string contact element disposed at the bridge body and is placed in the receiver groove;

FIG. 4 an embodiment forms of the bridge insert according to the invention with a different cross-section and a differently formed profile shaped string contact element;

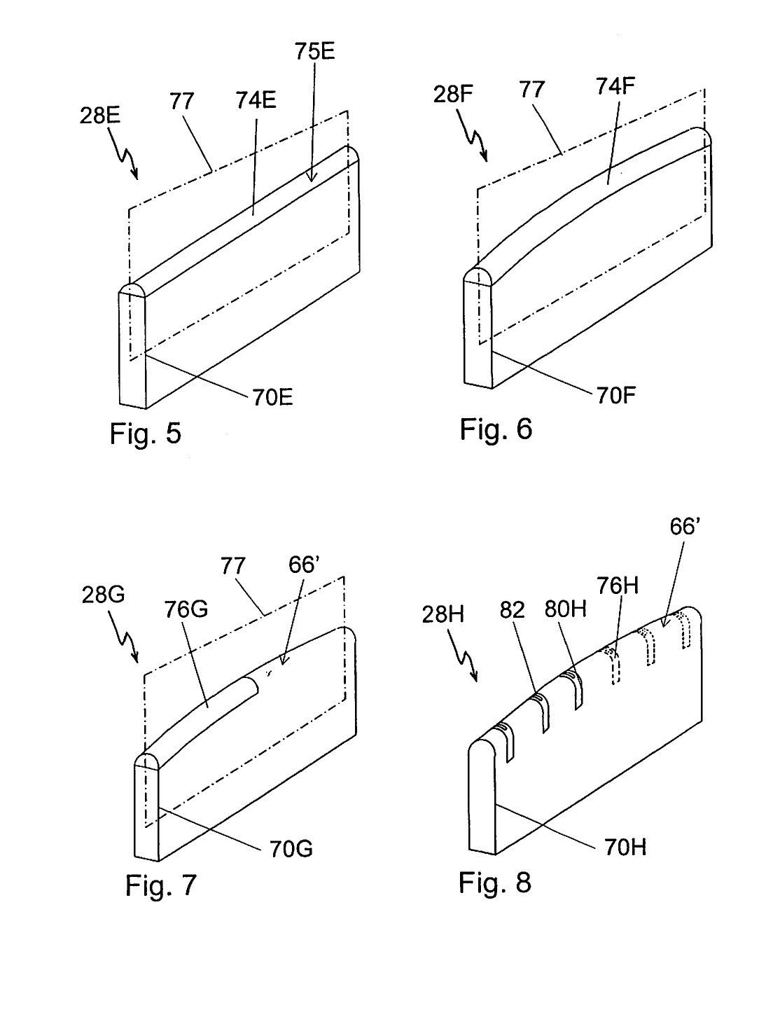

FIG. 5 a perspective view of the bridge insert with a string contact element extending as a straight line over the complete length of the bridge body;

FIG. 6 is a perspective view of a bridge insert with a string contact element extending convex bent over the complete length of the bridge body relative to the middle plane;

FIG. 7 in a perspective view of the bridge insert with a bent convex string contact element section relative to the bridge middle plane extending only in part over the length of the bridge body;

FIG. 8 a perspective view of a bridge insert with application grooves taken out of an upper narrow side of a bridge body and the application grooves having a distance relative to each other, wherein the string contact element sections are placed in the coordinated insertion grooves;

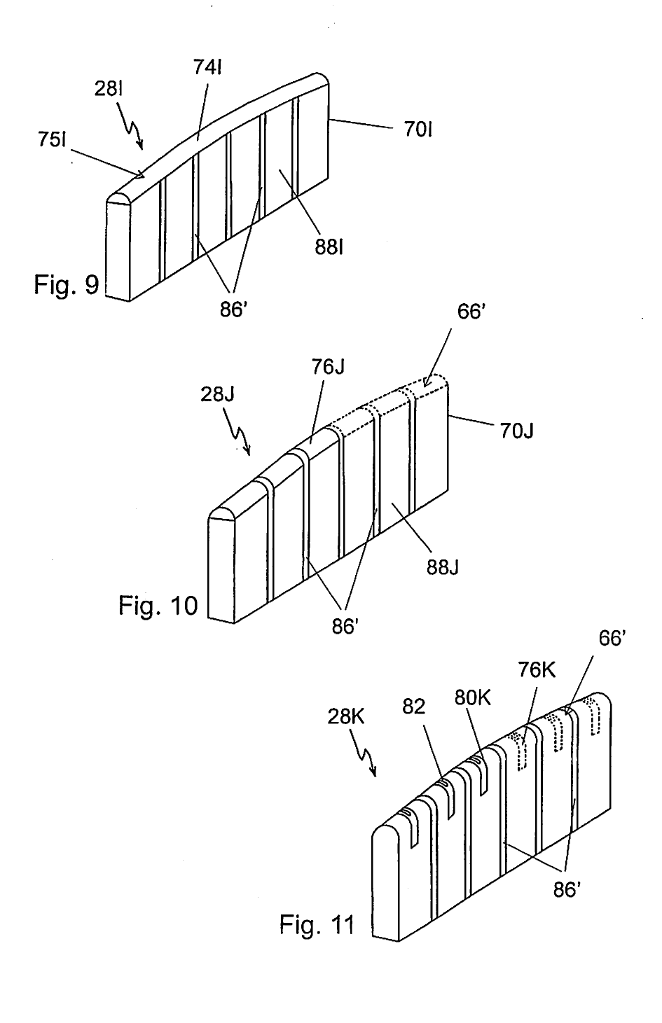

FIG. 9 a perspective view of the bridge insert, wherein the bridge body of the bridge insert is subdivided over the complete height by partying seams into the bridge body sections, wherein the partying seams are filled with rubber elastic material and movably connected to each other, and the string contact element of the bridge insert extends as a single piece and convex bent extends over the bridge body sections arranged in a row and over the partying seams;

FIG. 10 is a perspective view of a bridge insert wherein the bridge body of the bridge insert is subdivided over the complete height by partying seams, filled with rubber elastic material, and the bridge body sections are movably connected to each other, wherein the respective strings rest on the string contact element section disposed at the bridge body section and the other strings rest immediately on the upper narrow side of the bridge body section.

FIG. 11 a perspective view of a bridge insert, wherein the bridge body of the bridge insert is subdivided by partying seams into bridge body sections over the complete height, wherein the partying seams are filled with rubber elastic material and connect the bridge body sections movably to each other, wherein the bridge body sections exhibit placement grooves taken out on the upper narrow side of the in the bridge body sections and wherein the bridge contact element sections are placed in the corresponding and coordinated placement grooves;

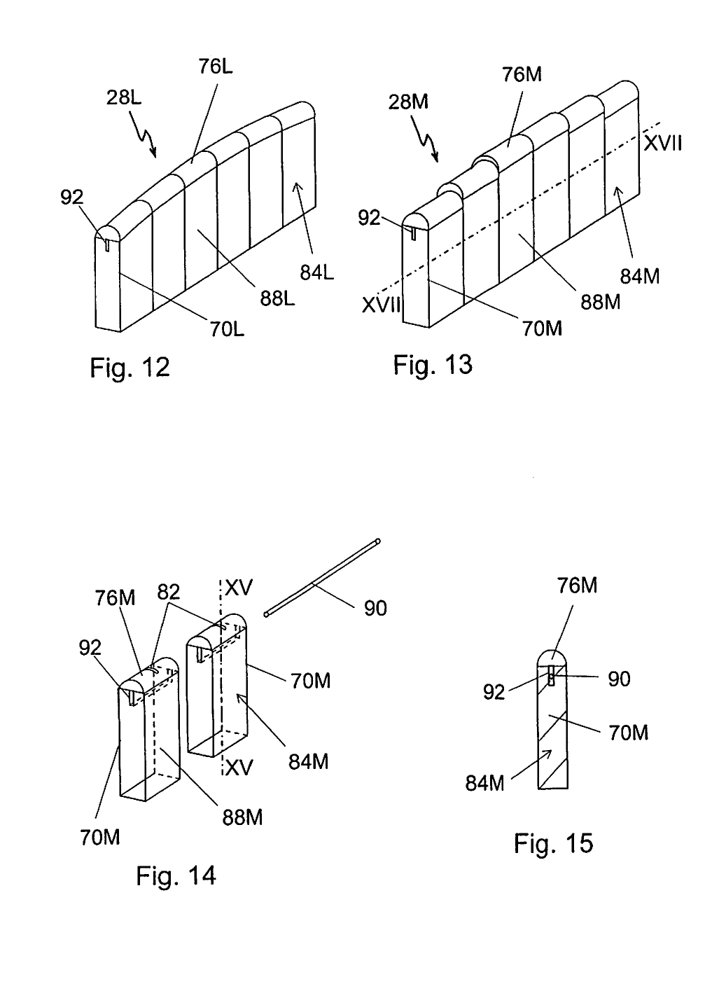

FIG. 12 a perspective view of a bridge insert, which is subdivided over the total height with partying seams into bridge insert sections, wherein the bridge insert sections are disposed at each other and the string contact element sections (relative to the bridge middle plane) form a continuous and convex bent support face over the complete length of the bridge insert;

FIG. 13 a perspective view of a bridge insert, which bridge insert is subdivided over the full height by partying seams into bridge insert sections, wherein the bridge insert sections are laying at each other and exhibit a different height;

FIG. 14 and exploded view of two bridge insert sections of FIG. 13, which can be aligned relative to each other by way of a guide wire;

FIG. 15 a cross-sectional view through the bridge insert section of FIG. 14 along the section line XV-XV with a groove at the end of the bridge body sections remote to the instrument body for the guide wire;

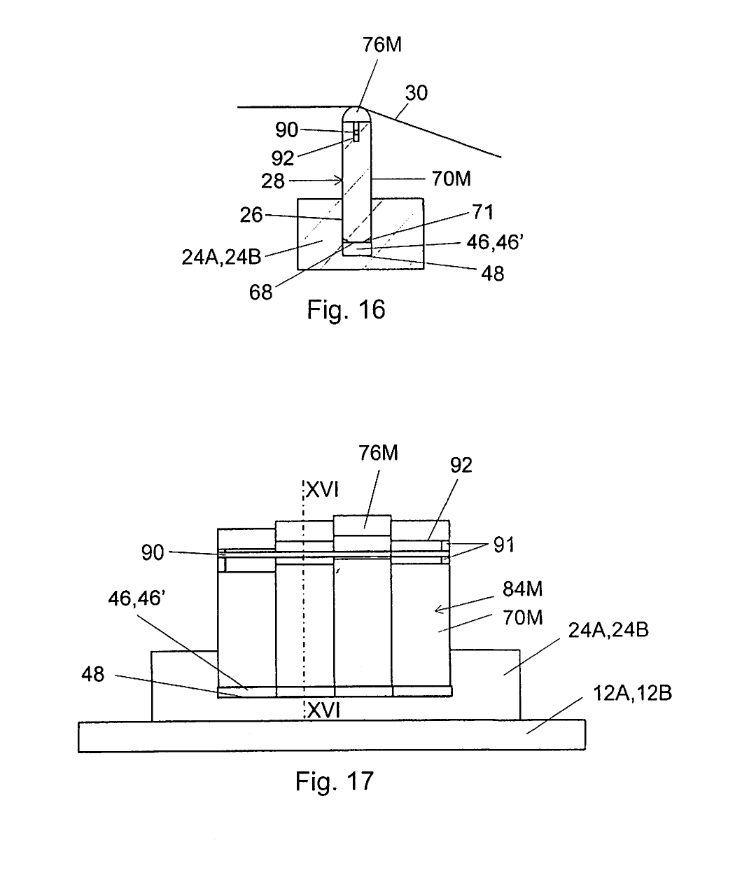

FIG. 16 a cross-sectional view along the section line XVI-XVI of FIG. 17 through the bridge insert and the bridge, wherein oscillations pickup receiver elements coordinated between the bridge insert sections and a floor of the receiver groove of the bridge and wherein the bridge insert sections are aligned relative to each other by way of the guide wire led in the groove;

FIG. 17 a longitudinal sectional view along section line XVII-XVII of FIG. 13 for illustrating the construction and incorporation of four bridge insert sections and oscillation pickup receiver elements disposed below in the receiver groove of the bridge, wherein the receiver groove is disposed on the surface of the instrument body; and

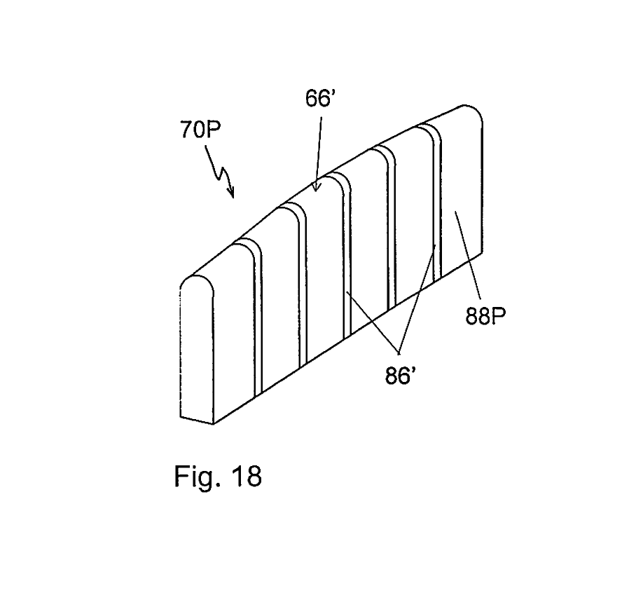

FIG. 18 a perspective view of a bridge insert with several bridge body sections separated from each other by partying seams, wherein the mold seams are filled with rubber elastic material in order to movably connect the bridge body sections to each other.

A guitar 10A shown in FIG. 1 is known for example from German printed patent document DE 10352 420 A1 and comprises a rugged instrument body 12A with the gripping board 14 as well as the body support 16 arranged at the instrument body 12A. The body support 16 is for example known from the international patent document WO 00/25296 and serves particular for mechanically supporting the instrument body 12A during playing the guitar 10A.

A bridge arrangement 22A is placed on an upper side 20 of the instrument body 12A at an end region 18 of the instrument body 12A disposed remotely to the gripping board 14. The bridge arrangement 22A comprises a bridge 24A and a bridge insert 28 according to the invention and inserted into a receiver groove 26 (compare FIG. 3). The detailed construction of the bridge insert 28 according to the invention is explained and illustrated in detail in connection with FIG. 3.

The present example shows six strings 30 with their first ends 32 attached at a free end 34 of the gripping board 14 disposed remote from the bridge arrangement 22A, pulled from there over the gripping board 14 and the instrument body 12A to the bridge arrangement 22A, and then resting on the bridge insert 28 of the bridge arrangement 22A through a feed opening 38A in the bridge 24A through a coordinated tuning screw 40 of a tensioning device (not shown) in a conventional way, such as for example according to the German printed patent document DE 103 52420 A1. Correspondingly, the tensioning device is placed in a hollow chamber (not shown) of the instrument body 12A and only the tuning screws 40 for the tuning of the strings 30 are accessible from the outside.

Such a guitar 10A has a very quiet sound because of the rugged instrument body 12A, since the body sound, resulting from the strings 30 placed into oscillations, in fact is transferred over the bridge insert 28 and the bridge 24A, however the rugged instrument body 12A and owned vehicle amplified the body sound. Correspondingly an oscillation pickup receiver element 46 (compare FIG. 3) for each string 30 is arranged between the bridge insert 28 and a floor 48 in order to transform the transferred body sound of the respective strings 30 into an electrical signal, wherein the electrical signal can be amplified by way of an electrical amplifier.

A further guitar 10B shown in part in FIG. 2 comprising a hollow shape instrument body 12B with a sound hole 50 placed into an upper side 20B of the instrument body 12B. The hollow shape instrument body 12B forms a resonance body and brings the body sound to ring out, wherein the body sound is transferred from the strings 30 placed in oscillations through a bridge arrangement 22B onto the instrument body 12B.

The bridge arrangement 22B is solidly placed on the upper side 20B of the instrument body 12B, and six springs 13 are tensioned over the bridge arrangement 22B in the present case. The bridge arrangement 22B employed in FIG. 2 comprising a bridge 24B as well as the bridge insert 28 according to the present invention and is explained in detail in connection with FIG. 3.

The six strings 30 are held at the bridge 24B at an end 52 on the side of the bridge in each case by a sleeve 54 or by a knob 56, and are led through a corresponding feed through 62 in the bridge 24B to a tensioning device at the head (not shown) of the guitar 10B, wherein the strings 30 are resting only on the bridge insert 28 according to the invention between a feed opening 38B at the bridge 24B and the tensioning device and are otherwise freely present in the air.

The oscillations pickup receiver element 46 coordinated is arranged, as the shown in FIG. 3 in cross-section, for each string 30 between the bridge insert 28 according to the invention and the floor 48 of the receiver groove 26 of the bridge 24B in the present example in order to amplify the body sound, as presented above in connection with FIG. 1, electronically by way of an electrical amplifier. FIG. 3 shows in fact by example the bridge arrangement 22B according to FIG. 2, however with respect to the construction and application of the bridge insert 28 according to the present invention into the receiver groove 26 of the bridge 24B the same considerations hold as were presented for the guitar 10A according to FIG. 1.

The bridge arrangement 22B is solidly placed on the upper side 20B of the instrument body 12B and the corresponding strings 30, which are held at the end 52 on the bridge side of the bridge 24B by this sleeve 54 or, respectively, the knob 56 at the bridge 24B, rest on the bridge insert 28 in front of the corresponding feed openings 38B of the bridge 24B.

The bridge 24B is formed in the shape of a profile and exhibits a flat, ledge like bridge region 58B and a receiver region 60B furnished with a feed through 62 for the corresponding string 30.

The ledge like bridge region 58B exhibits the receiver groove 26 running perpendicular to the strings 30B for the bridge insert 28.

The bridge insert 28 is such applied and is movably supported at the groove flanks 26′, 26″ of the receiver groove 26 in the receiver groove 26 in the present example, that the pretension and vibration caused string pressure forces of the strings 30 attacking at the bridge insert 28 are transferred over an upper narrow side 66 of the bridge insert 28 as body sound onto the coordinated oscillation pickup receiver elements 46. Here the oscillations pickup receiver elements 46 for the respective string 30 are disposed between the bridge body 70 of the bridge insert 28 and the floor 48 of the receiver groove 26 of the bridge 24B. The body sound transferred immediately to the oscillations pickup receiver elements 46 is correspondingly electronically amplified by way of the electric amplifier.

An additional amplification of the body sound is performed in the present case through the indirect transfer of the body sound onto the resonance body formed as a hollow shaped instrument body 12B. Indirect transfer of the body sound means that the body sound is not directly transferred from the bridge insert 28 to the instrument body 12B, but is transferred indirectly over the oscillation pickup receiver element 46, which in this case serves additionally as a body sound transfer agent.

It is however also conceivable that the bridge insert 28 according to the present invention lies with a lower narrow side 68 of the bridge insert 28 directly, that is immediately at the floor 48 of the receiver groove 26 of the bridge 24B and exhibits no oscillation pickup receiver element 46 transfer of the body sound occurs from the bridge arrangement 22B onto the instrument body 12B.

The bridge insert 28 according to the present invention exhibits a bridge body 70 inserted into the receiver groove 26 of the bridge 24B and a string contact element 74 disposed at the end 72 of the bridge body 70, wherein the end 72 is disposed remote from the instrument body 12B. The string contact element 74 serves as a support for the respective strings 30 and is formed harder than bridge body 70 in order to prevent the cutting in of the strings 30 into the bridge insert 28 and to keep the sound quality constant over long time periods.

The bridge inserts 28A-28D shown in FIG. 4 comprise the bridge bodies 70A-70D and in each case a profile shape formed string contact element 74A-74D arranged at the bridge body 70A-70D.

The string contact elements 74A-74C are furnished with a convex rounded support face 75A-75C for the corresponding string 30 on the upper narrow side 66 directed away from the instrument body 12A, 12B (FIGS. 1 and 3). The support faces 75A-75C are particular preferably formed like a semi circle, such that the respective strings 30 can be led with low tension during tuning and stringing.

It is however also possible that the upper narrow side 66 directed away from the instrument body 12A or, respectively, 12B exhibits a convex tipped concurring support with rounded support edge 75D, according to the string contact element 74D of the bridge insert 28D for the strings 30. The bridge inserts 28E-28M shown in FIG. 5 through FIG. 13, which are inserted into the receiver groove 26 of the bridge 24A according to FIG. 1 or, respectively, of the bridge 24B according to FIG. 2 as described in FIG. 3, present only preferred embodiments of the present invention and do not exclude further combinations with the herein recited embodiments, even though the combination is not explicitly recited here.

The string contact element 74E of the bridge insert 28E extends according to the embodiment of FIG. 5 in a longitudinal direction along the bridge 24A or, respectively, 24B, clamped over a bridge middle plane 77, straight line over the complete length of the bridge body 70E. Here the bridge body 70E is formed as a profile, exhibits over the complete length of the bridge body 70E exhibits a rectangular cross-section and is insertable into the receiver groove 26 of the bridge 24A or, respectively, 24B.

String contact element 74E disposed at the bridge body 70E is formed as a profile in the present case, exhibits a semicircular cross-section and is furnished with the preferably semicircular formed support face 75E for the corresponding strings 30 of the guitar 10A or, respectively, 10B.

The bridge bodies 70F-70H shown in FIG. 6 to FIG. 8 are convex bent in the direction toward the string contact element 74F-74H over the full length, wherein the string contact elements 74F-74H are formed differently, in contradistinction to the bridge body 70E according to FIG. 5.

The string contact element 74F according to FIG. 6 is formed as a single piece and extends relative to the longitudinal direction along the bridge 24A or, respectively, 24B spanned bridge middle plane 77, convex bent over the full length of the bridge body 70F. Correspondingly all strings 30 are lying on the string contact element 74F.

The string contact element 74G according to FIG. 7 extends with respect to the bridge middle plane 77 spanned in longitudinal direction along the bridge 24A or, respectively, 24B, convex bent only in part, in this case over half the length of the bridge body 70G and forms a string contact element section 76G. Correspondingly, three strings 30 are lying on the string contact element section 76G and the other three strings 30 are lying on an upper narrow side 66′ of the bridge body 70G.

The bridge insert 28H according to FIG. 8 exhibits three taken out and at a distance to each other located insertion grooves 80H on the upper narrow side 66′ of the bridge body 70H. The three string contact element sections 76H furnished with a corresponding guide groove 82 are inserted into the three insertion grooves 80H. The guide grooves 82 serve for the improved guiding of the respective three strings 30 and the other three strings 30 are lying directly on the upper narrow side 66′ of the bridge body 70H. The string contact element sections 76H are preferably glued in the insertion grooves 80H with the purpose that the string contact element sections 76H do not fall out during playing of the strings 30.

However it is also conceivable that for all six strings 30, the corresponding string contact element sections 76H are inserted into the corresponding insertion grooves 80H and are furnished with the guide groove 82, as is additionally indicated by dashed lines in FIG. 8.

It is mentioned at this point that the use of the guide groove 82 can be provided for all embodiments according to FIG. 1 through FIG. 18 of the present application in order to improve the guiding of the respective strings 30, also where this is not shown in some embodiments for purposes of clarity.

The bridge bodies 701 of the bridge insert 281 is subdivided in bridge body sections 881 by partying seams 86 over the complete height in the embodiment according to FIG. 9. The partying seams 86 are filled with rubber elastic material 86′ in order to movably connect the bridge body sections 88I to each other. The string contact element 74I of the bridge insert 28I is formed as a single piece and extends convex bent over the bridge body sections disposed in a row and the rubber elastic material 86′. All strings 30 lying correspondingly on the string contact element 74I formed as a single piece and in comparison to the embodiment according to FIG. 6, the body sound is transferred separately through the respective bridge body sections 881 onto the oscillation pickup receiver elements 46 or, respectively, the instrument body 12A or, respectively, 12B.

The bridge body 70J of the bridge insert 28J is subdivided into six bridge body sections 88J by partying seams 86 over the complete height according to the embodiment according to FIG. 10. The partying seams 86 are filled with rubber elastic material 86′ in order to movably connect the six bridge body sections 88J to each other. In the present example there are three string contact element sections 76J disposed on three bridge body sections 88J and the other three bridge body sections 88J are formed without string contact element sections 76J. Correspondingly, three strings 30 are lying on the three string contact element sections 76J and the other three strings 30 are lying on the upper narrow sides 66′ of the other three bridge body sections 88J.

However it is also conceivable that all six bridge body sections 88J exhibit the corresponding string contact element section 76J, as is indicated in FIG. 10 with dashed lines. Correspondingly all six strings 30 are lying on the respective string contact element sections 76J of the bridge insert 28J.

Incidentally, it is also conceivable but not shown that the string contact element section 76J can as a single piece extend over two or more bridge body sections 88J disposed in a row and the rubber elastic material 86′ in order to guide more than one strings 30 on the respective string contact element section 76J.

In contradistinction to the embodiment according to FIG. 10, the string contact element section 76K according to FIG. 11 is formed like that of FIG. 8. Correspondingly three string contact element sections 76K are inserted into the taken out and at a distance provided three insertion grooves 80K of the three bridge body sections 88K and the other three bridge body sections 88K are formed without insertion grooves 80K.

In addition it is also conceivable as already recited in connection with FIG. 8 that also the bridge insert 28K according to FIG. 11 (indicated with dashed lines) all six bridge body sections 88K are furnished with the string contact element sections 76K inserted into the insertion groove 80K.

The bridge insert 28L, in the embodiment according to FIG. 12, is subdivided in bridge insert sections 84L by partying seams over the full height, wherein the bridge insertion sections 84L rest at each other. The individual bridge insert sections 84L are formed out of the bridge body sections 70L and the therewith arranged string contact element section 76L. A groove 92 is furnished in each case on the upper narrow side 66′ of the bridge body sections 70L, wherein the groove 92 serves to align the bridge insert sections 84L in the receiver groove 26 of the bridge 24A or, respectively, 24B by way of a guide wire 90 (compare FIG. 14). The string contact element sections 76L resting at each other form a continuous and convex bent support face relative to the bridge middle plane 77 over the complete length of the bridge insert 28L. The corresponding string contact element section 76L is furnished for a respective string 30. This construction is again associated with the advantage that the body sound is separately for each string 30 transferred over the corresponding bridge insert section 84L onto the oscillation receiver element 46 or, respectively, the instrument body 12A or, respectively, 12B.

In contradistinction to the embodiment according to FIG. 12, the bridge insertion sections 84M according to FIG. 13 are formed of different height relative to each other such that the bridge contact element sections 76M do not form a continuous support face over the complete length of the bridge insert 28M, but are arranged staggered to each other.

In order to align the individual bridge insert sections 84M according to FIG. 13, the bridge insert sections 84M are entered with the guide wire 90 into the corresponding grooves 92 in end regions of the bridge body sections 88M turned toward one of the string contact element sections 76M. Incidentally, the same holds also for the bridge insert sections 84L according to FIG. 12, however is not further illustrated in the drawings. FIG. 14 shows in an explosive view by way of example two bridge insert sections 84M according to FIG. 13, wherein the grooves 92 of the respective bridge body sections 88M extend over the complete length of the bridge body sections 88M in order to feed the guide wire 90 for completely performing aligning of the individual bridge insert sections 84M.

FIG. 15 shows in particular the cross-section through one of the bridge insert sections 84M along the section line XV-XV of FIG. 14 and illustrates correspondingly the feeding of the guide wire 90 into the groove 92 of the bridge body section 70M.

FIG. 16 shows the cross-section along the section line XVI-XVI of FIG. 17 with the constructing and incorporation of the bridge insert 28M according to FIG. 13 in the bridge 24A or, respectively, 24B. Here the corresponding oscillation pickup receiver elements 46 are disposed between the bridge body 70M and the floor 48 of the receiver groove 26 of the bridge 24A or, respectively, 24B. In the respective oscillations pickup receiver elements 46 are disposed here between the bridge body 70M and the floor 48 of the receiver groove 26 of the bridge 24A or, respectively, 24B. In addition, the guide wire 90 guided through the respective grooves 92 is schematically presented for alignment of the four bridge insert sections 84M according to FIG. 17.

The oscillations pickup receiver elements 46 are preferably piezo elements 46′ in order to convert the oscillations of the respective strings 30 into the electrical signal, which can be amplified with an electrical amplifier (not shown). In this respect it is mentioned that the use of oscillation pickup receiver elements 46 for the corresponding string 30 is performed throughout for all above recited embodiments according to FIG. 1 through 13, in order to amplify the body sound of the strings 30 placed under oscillations. Here it is unimportant if the instrument body 12 is a resonance body, this is the case for example with classic guitars 10B and as shown in FIG. 2, or as a rugged instrument body 12, as is the case for example with e-guitars 10A and as shown in FIG. 1.

The bridge bodies 70 of the bridge insert 28 can have a manual holder 71 on the lower narrow side 68 or a rounding in order to enable a clean lying.

FIG. 17 shows by way of example the construction and incorporation of four different height formed bridge insert sections 84M according to FIG. 13 in a longitudinal section along the section line XVII-XVII, which are inserted into the receiver groove 26 of the bridge 24A or, respectively, 24B and this bridge 24A or, respectively, 24B is arranged at the top side 20 of the instrument body 12A or, respectively, 12B. Preferably, the grooves 92 of the individual bridge insert sections 84M are so deep taken into the respective bridge body section 88M, that the guide wire 90 can run parallel to the floor 48 of the receiver groove 26 of the bridge 24A or, respectively, 24B, independent from the situation if the bridge insert sections 84 are formed of the same height or if they are formed of different heights. This allows the straight insertion of the guide wire 90 through the grooves 92 and the corresponding low tension presence of the guide wire 90 in all grooves 92 of the corresponding bridge insert sections 84M. The guide wire 90 is attached to the groove 92 with an adhesive 91, in particular with an epoxy resin.

The arrangement of one oscillation pickup receiver element 46 in each case between the floor 48 of the bridge 24A or, respectively, 54B and the corresponding bridge body section 88L. Correspondingly, the body sound is transferred immediately onto the respective oscillation pickup receiver elements 46 and through intermediary onto the instrument body 12A or, respectively, 12B.

It is to be mentioned with respect to the string contact elements 74 or, respectively, string contact element sections 76 that these string contact elements 74 preferably a court use from a thin bent sheet metal.

As shown in FIG. 18 it is otherwise also conceivable to furnish the bridge body 70P, which is over its complete height subdivided through partying seams 86 into bridge body sections 88P, wherein the partying seams 86 are filled with rubber elastic material 86′ and the bridge body sections 86P are movably connected to each other, wherein no bridge body section 88P is coordinated to a harder formed string contact element section. Correspondingly the strings 30 would rest immediately on the upper narrow sides 66P′ of the bridge body sections 88P.

If the string contact element should be made of a metal, then the string contact element should have a hardness of at least 180 HV (Vickers). If the string contact element should be made of plastic or a plastic resin, then the string contact element should have a hardness of at least 75 Shore (hardness D). If the string contact element should be made of a material in the nature of a mineral, then the string contact element should have a hardness of at least 500 HV (Vickers). The string contact element 74 can have a hardness which is at least twice the hardness of the bridge body 70.

1. String element, in particular guitar, with an instrument body (12A, 12B), with a bridge (24A, 24B) arranged on an upper side (20A, 20B) of the instrument body (12A, 12B), with a receiver groove (26) in the bridge (24A, 24B), wherein the receiver groove (26) runs perpendicular to the strings (30) of the instrument, and with a bridge insert (28), which is such inserted into the receiver groove (26) that the string to pressure forces caused by the pretensioning and by the vibrations of the strings (30) attacking at the bridge insert (28) and a lower narrow side (68) of the bridge insert (28) rests at least indirectly on a floor (48) of the receiver groove (26), wherein the oscillations of the strings (30) are transferred as body sound by way of the bridge insert (28), wherein the bridge insert (28) exhibits a bridge body (70) inserted into the receiver groove (26) of the bridge (24A, 24B) and exhibits a string contact element (74) disposed at an end (72) of the bridge body (70) directed away from the instrument body (12A, 12b), wherein the string contact element (74) serves as a support for the strings (30) and is formed harder than the bridge body (70), in order to prevent the cutting of the strings (30) into the bridge insert (28).

2. String instrument according to claim 1, wherein the string contact element (74) is formed as a profile and exhibits on an upper narrow side (66), turned away from the instrument body (12A, 12B), a convex rounded, in particular semicircular shaped rounded support face (75A-75C) or a convex tipped running support with rounded support edge (75D) for the respective strings (30).

3. String instrument according to claim 1, wherein the string contact element (74) exhibits a guide groove (82) for the respective string, wherein the respective string (30) is led through the guide groove (82).

4. String instrument according to claim 1, wherein the string contact element (74) extends in a straight line or convex bent over the complete length of the bridge body (70) or only in part over the length of the bridge body (70) with reference to a bridge middle plane (77) spanned in longitudinal direction of the bridge.

5. String instrument according to claim 1, wherein the string contact element (74) exhibits a string contact element section (76) for each respective string (30) and wherein the string contact element sections (76) are disposed at a distance from each other.

6. String instrument according to claim 5, wherein the bridge body (70) exhibits an insertion groove (80) for each string contact element section (76) and wherein the respective string contact element section (76) is inserted into the coordinated insertion groove (80).

7. String instrument according to claim 1 wherein the bridge body (70) is subdivided by partying seams (86) into bridge body sections (88) over the complete height, wherein the corresponding string contact element section (76) is disposed at each bridge body section (88) or the string contact element section (76) extends as a single piece over several bridge body sections (88) arranged in a row successively and in between present partying seams (86), and that preferably the partying seam (86) is filled with a soft material, in particular with a rubber elastic material (86′).

8. String element according to claim 5 wherein an upper narrow side (66′), turned toward the string contact element section (76) of bridge body sections (88), exhibits a groove (92), wherein a common guide wire (90) is guided through the groove (92) in order to align at least two next to each other disposed bridge insert sections (84).

9. String instrument according to claim 1, wherein an oscillation pickup receiver element (46), in particular a piezo element (46′), is disposed between the bridge insert (28) and the floor (48) of the receiver groove (26) of the bridge (24A, 24B), preferably for each string, in order to transform the oscillations of the strings into an electrical signal, wherein the electrical signal can be amplified by way of an electrical amplifier.
